(19) United States
(12) Patent Application Publication
(10) Pub. No.: US 2010/0040852 A1
(43) Pub. Date: Feb. 18, 2010

(54) LOAD FLOOR

(75) Inventor: Christoph Holzapfel, Eschwege (DE)

Correspondence Address: RATNERPRESTIA, P.O. BOX 980, VALLEY FORGE, PA, 19482, US

(73) Assignee: Friedola TECH GmbH, Geismar (DE)

(21) Appl. No.: 12/542,769

(22) Filed: Aug. 18, 2009

(30) Foreign Application Priority Data
Aug. 18, 2008 (DE) 202008011018.1

(51) Int. Cl. B32B 3/26

(52) U.S. Cl. 428/219; 428/304.4; 428/220

(57) ABSTRACT

A floor inlay for a container and/or container floor, comprising a first material layer comprising an upper side and a lower side; and at least a second material layer comprising an upper side and a lower side. The first material layer is a plastic foam layer and the second material layer is a hollow chamber structure consisting of plastic. The upper side of the first material layer is connected to the lower side of the second material layer such that the first material layer cannot be moved relative to the second material layer. At least an upper side of the floor inlay/container floor is a closed area.

### REFERENCE TO RELATED APPLICATIONS

This application claims priority to German Patent Application No. DE 202008011018.1 filed Aug. 18, 2008, the contents of such application being incorporated in its entirety by reference herein.

### BACKGROUND OF THE INVENTION

1. Technical Field

The invention relates to a floor inlay for a container, preferably a floor inlay for a heavy goods vehicle (HGV) and/or its load area or a bus and/or the passenger space and/or the load space of the bus. The floor inlay is constructed from at least two material layers: a lower layer which lies directly on the container floor; and an upper layer which lies over the lower layer. The invention also relates to a container floor and/or load floor.

2. Description of Related Art

Floor inlays are known in the prior art which are for example placed onto the load area of an HGV, in order to protect the metal, and/or the varnish layer which seals the metal, against damage from the payload. Such load floors are generally produced from wood. Wood has the disadvantage that it absorbs moisture and thus swells, wherein the uptake of water simultaneously increases the weight of the floor. Wood is also a natural material which rots over time and then has to be replaced. Wooden slats or wooden plates as such also exhibit a smooth surface, such that the wood has to be roughened, profiled or covered with a rubber mat on its upper side, in order to make it more difficult for the loaded goods to slide. If a rubber mat does lie on the wooden floor, then it is in turn particularly at risk of being damaged during loading and unloading by corners or edges of the payload and/or by the loading and/or unloading devices. Both purely wooden floor inlays and those with a rubber covering are difficult to clean.

### SUMMARY OF THE INVENTION

In at least one aspect, the invention provides a floor inlay for a container or the floor of a container, which is durable and can be easily cleaned and does not absorb moisture.

The floor inlay for a container or the container floor of at least one aspect of the invention is formed from at least two material layers: a first material layer comprising an upper side and a lower side; and at least a second material layer which likewise comprises an upper side and a lower side, wherein the lower, first material layer is formed by a plastic foam layer and formed for example from a polypropylene foam; the upper, second material layer is formed by a hollow chamber structure. The upper side of the first material layer is connected to the lower side of the second material layer such that the two material layers cannot be moved relative to each other. At least the upper side of the second material layer is a closed area, for example in the form of a closed skin.

The hollow chamber structure is preferably a tri-laminate comprising a lower layer or floor layer, an upper layer or covering layer and a spacing layer or cup layer arranged between them. It is preferred if the hollow chamber structure is formed from a plastic which is reinforced with talcum.

It is preferred if at least the lower side of the first material layer is also designed in the form of a closed skin. Water or dirt cannot then penetrate into or under the lower side of the first material layer, and the abutting area of the floor inlay on the container floor is maximized. The closed skin of the lower side advantageously comprises a surface or surface structure which counteracts sliding by the floor inlay on the container floor. If the floor directly forms the container floor, then it prevents spray water or other contaminants from penetrating into the container. The plastic which forms the first material layer can be open-pored or closed-pored; a plastic is preferably selected which has good properties with regard to noise absorption.

The at least two material layers which form the floor inlay/container floor can be glued or fused to each other; the second material layer can be laminated to the first material layer, and vice versa. The two material layers can however also be connected in any other way, as long as the connection prevents a relative movement of the two material layers relative to each other. The connection between the at least two material layers should also be such that neither water nor dirt can come between the two layers.

It is particularly preferred if the at least two material layers are formed from the same plastic or from similar plastics. This facilitates and optimises the options for reconditioning and/or recycling the floor inlays/container floors of the invention. The material thus recovered can then for example be used, whole or as an admixture, in the production of new floor inlays or other parts.

In order to manufacture the floor inlays/floors, each of the material layers can be produced individually and then connected, for example glued or fused, to the other material layer or layers to form the floor inlay/container floor. It is however preferred if, when manufacturing the hollow chamber structure which forms the second material layer, the first material layer is applied online. To this end, the first material layer can on the one hand be inputted into the production facility for the hollow chamber structure as a web material, for example a supply reel. The two material layers are then connected in the machine following the production of the hollow chamber structure. Alternatively, both material layers can also be simultaneously produced and then joined together in one facility or can be produced in one production process without being subsequently combined.

In addition to the two material layers described, the floor inlay/container floor can comprise another, third material layer which in the language of the application then forms the upper layer, while the second layer is then arranged between the first layer and the third layer. In this arrangement, the hollow chamber structure can be open both on its upper side and on its lower side; the hollow chamber layer can for example exhibit a honeycombed structure or a structure consisting of adjacent rings or other suitable shapes. The use of a hollow chamber structure comprising a lower layer, an upper layer and a cup layer lying between them is however preferred.

Like the other two material layers, the third material layer comprises an upper side and a lower side; the lower side of the third material layer is glued, fused, laminated or otherwise connected to the upper side of the second material layer, as has already been described above. The upper side of the third material layer is preferably formed as a closed skin; it can comprise a surface structure which inhibits sliding by containers placed on it. The closed surface also offers the advantage that the material layer can for example be printed on, such that the visible surface of the floor inlay/container floor can be correspondingly decorated.

In order to be able to easily use and as far as possible re-use the floor inlay/container floor, it is advantageous if the third material layer also consists of a plastic which comes from an identical or similar family of plastics as the plastic or plastics of the other two material layers or of one of the other two material layers.

The Con-Pearl® material of friedola TECH, which is a three-dimensionally moulded central sandwich layer on-to which a smooth plastic sheet is laminated on both sides, can for example be used as a particularly suitable hollow chamber material; the third material layer or at least its visible surface can be formed from a solid fabric, for example a polypropylene (PP) fabric, or from an interlace. In order to increase the durability of the visible surface of the third material layer, it can additionally also comprise a thermoplastic olefin (TPO) coating. The surface can be rubbery, which for example increases the security against slipping when it is used as the vehicle floor in the passenger region of a bus. If it is an interlace, then it can be either a weft knitted interlace which is knitted using only one thread or a warp knitted interlace in which many threads are used.

As already described above for the two-ply floor inlay/container floor, the three-ply floor inlay/container floor can be manufactured in different ways. The third layer can for example be latterly applied, for example glued or fused, to the surface of the hollow chamber structure. It is however also possible to input the first material layer and the second material layer into the production facility for the hollow chamber structure as a web product and to connect the three layers inline in the production facility after the hollow chamber structure has been completed. Lastly, it is also possible for all three material layers to be manufactured and joined together in one production facility.

The containers in which the floor inlay is to be laid can be large transport crates, freight containers, commercial vehicles or parts of commercial vehicles. Preferably, however, it concerns the load areas of HGVs and the floor of the passenger space and/or load space of buses, railways and other means of transport, such as for example enclosures. Particularly when being used as the vehicle floor of buses or railways cars, the aforementioned use of a plastic having good noise absorbing properties for the first material layer is preferred, wherein the use of the floor inlay in accordance with the invention is not limited to the floor; where necessary, the floor inlay can also cover other walls of for example transport containers.

The floor inlay/container floor constructed in accordance with one or more aspects of the invention exhibits numerous advantages as compared to the known floor inlays/container floors, such as for example a veritable reduction in weight which allows a greater payload and/or reduces the vehicle's fuel consumption and therefore the amount of CO₂ expelled. The reduction in fuel consumption and/or the increased payload have a positive effect on the operating costs. The foam material on the lower side absorbs the road noise and also the noise of the moving machine parts such as for example the running noise of the tires, air noise and other sources of noise, mainly on the lower side of the vehicle. The floor inlay/container floor in accordance with the invention is characterised by excellent impact resistance and is resilient to scratching. The preferably uniform surface is moisture-resistant, easy to clean and resilient to dirt. This can be advantageous inter alia when transporting comestibles such as fruit or vegetables or when transporting live animals, since it can be thoroughly cleaned and/or disinfected afterwards, quickly and comprehensively. Another advantage is the long durability of the floor inlay of the invention under normal circumstances, as compared to conventional wooden floor inlays.

Additional elements can be worked into or attached to the floor inlay/container floor, preferably latterly. Depending on the use of the floor inlay/container floor, these can for example be lashing slits, lashing ear lugs, load space sliding door beadings, rear end edge beadings or half-cut grooves in one-part embodiments. Some or all of these perforations, embossments or grooves can also be provided or introduced into the floor inlay/container floor even during the production process of the floor inlay/container floor, wherein this will only be expedient in the case of mass-produced series of identical products.

The first material layer, which is preferably produced from PE foam, can exhibit a thickness of 2 to 10 mm; it is preferably between 2.5 and 5 mm thick, most particularly preferably 3 mm. The floor inlay/container floor can exhibit an overall thickness of 50 to 150 mm; it preferably exhibits a thickness of 80 to 120 mm, particularly preferably a thickness of 100±5 mm. The area load of the floor inlay/container floor should be around at least 3,000 kg/m² and the average area load around 3,800 kg/m², wherein the floor inlay/container floor should have a weight of about 4 kg per square metre (3,600 g/m² to 4,200 g/m²); preferably, the weight measures about 3,800 g/m².

Lastly, the case is also to be included whereby the floor inlay forms part of the container floor or the floor inlay alone forms the container floor. Thus, for example, the container can comprise only a floor framework, onto which the floor inlay in accordance with the invention is placed, only then producing a closed container floor.

The invention also relates to a method for manufacturing floor inlays/container floors, wherein in a facility for manufacturing a flat hollow chamber structure, at least one material layer is introduced into the facility from at least one supply reel or magazine at a point before or after the hollow chamber structure has been completed, and the material layer is combined with the completed or emerging hollow chamber structure and connected, for example glued, fused or laminated, to it inline.

If more than one material layer is supplied to the production of the hollow chamber structure, then both material layers can be supplied to the facility at the same point in the production process of the hollow chamber structure or each of the material layers can be supplied to the facility at a different point in the production process. Points in the production process are inter alia before the beginning of manufacturing the hollow chamber structure, during the process of manufacturing the hollow chamber structure, after the hollow chamber structure has been completed, and any conceivable intermediate point. The more than two material layers are also connected inline in the facility for manufacturing the hollow chamber structure.

As an alternative, one or more or all of the material layers which form the floor inlay/container floor together with the hollow chamber structure can be manufactured and connected to each other in the same facility.

The floor inlays/container floors can be manufactured in a plate-like form and then tailored to their specific use, wherein for example the rims of the end product can also be sealed off, for example by supplying heat, such that no open chamber of the hollow chamber structure is visible but rather a closed area is produced on the circumference of the floor inlay/container floor. They can be tailored for example by laser cutting, which can simultaneously seal the open sides. They can also however be tailored by milling the plate-like product or by cutting by means of a jet of water. Less preferred, but also conceivable at corresponding numbers of pieces, is to manufacture a tailored end product directly in the facility, wherein it is possible not only to automatically manufacture outer dimensions of the floor inlays/container floors but to additionally also three-dimensionally mould the material for the floor inlays, in order for example to adapt it to the shape of the container floor. This three-dimensional moulding can of course also be performed on plate-like material after it has been tailored or while it is being tailored, in an additional processing step in an additional processing machine.

### DESCRIPTION OF THE DRAWINGS

In the following, the invention is explained in more detail on the basis of an example embodiment. The figures and the description of the example embodiment are not however intended to restrict the invention in any way. Features which are only disclosed in the figures or in the description of the figures form part of the invention.

Individually, the figures show:

FIG. 1 illustrates a schematic construction of an exemplary load floor, in a cross-sectional view;

FIG. 2 illustrates a perspective top view onto a load floor in accordance with an exemplary embodiment of the invention;

FIG. 3 is a top view onto the load floor of FIG. 2;

FIG. 4 is a sectional detail of an exemplary load floor comprising various modifications; and

FIG. 5 is a sectional detail of an exemplary load floor comprising a beading for a load space door.

### DETAILED DESCRIPTION OF THE PREFERRED EMBODIMENTS

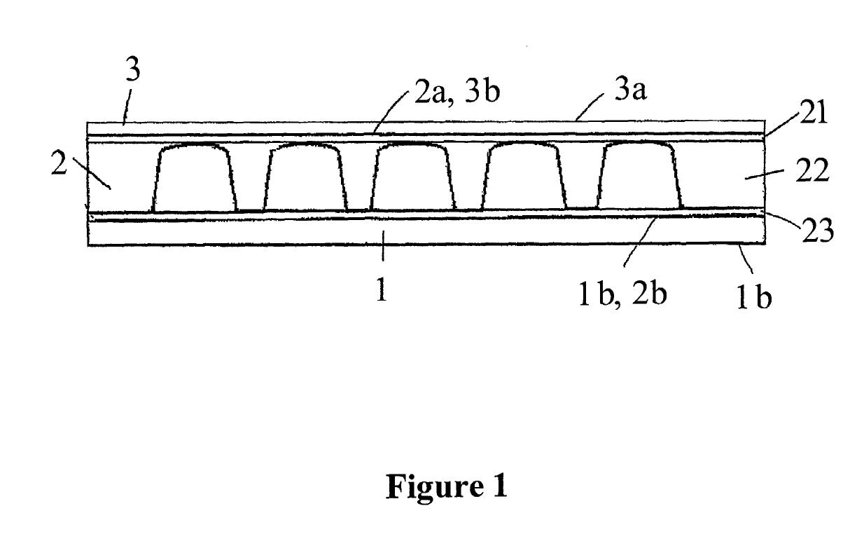

FIG. 1 shows a preferred construction of a floor inlay for a container which is constructed from three material layers: a lower material layer 1; an upper material layer 3; and a material layer 2 lying between them.

The lower or first material layer 1 is formed from a plastic foam layer and lies directly on the container floor. The plastic foam can be a foam comprising open or closed pores; an open-pored polypropylene foam can for example be used. The material layer 1 comprises an upper side 1a and a lower side 1b. The lower side 1b of the floor inlay, which preferably forms a closed skin, lies as far as possible over its whole area on the container floor. The visible surface of the lower side 1b can be roughened or structured and can for example comprise pimples or grooves in order to inhibit sliding by the floor inlay on the container floor.

The first material layer 1 can exhibit a thickness of 3 mm; it can however also be up to 10 mm thick, or thinner than 3 mm, for example 2 mm thick. It is preferred if the first material layer 1 exhibits good noise absorbing properties, such that noise which arises or is generated from the lower side of the container—for example, an HGV or bus—by mechanical parts, the tires or the air flowing under the container is reduced as far as possible. This can noticeably reduce the level of noise for example in the interior space of the bus.

A second material layer 2 is arranged opposite the upper side 1a of the first material layer 1 and likewise comprises an upper side 2a and a lower side 2b, wherein the upper side 1a of the first material layer 1 and the lower side 2b of the second material layer 2 lie directly opposite each other. The two material layers 1, 2 are connected, for example glued, fused or laminated, to each other in this region, wherein the upper side 1a can be connected to the lower side 2b over its whole area or only in regions or only at points. Connecting it over its whole area, i.e. completely gluing, fusing or laminating the two opposing sides 1a, 2b, is preferred, such that the first material layer 1 and the second material layer 2 also cannot be moved relative to each other in regions, but can only be shifted and lifted as a common layer.

The second or middle material layer 2 consists of three layers: an upper layer 21; a lower layer 23; and a spacing layer 22 lying between them, wherein the upper layer 21 and the lower layer 23 are formed as flat plates, while the spacing layer 22 exhibits a three-dimensional, non-plate-like structure. A tri-laminate is thus produced, such as the Con-Pearl® material which can for example be procured from the firm of friedola TECH.

The spacing layer 22 substantially ensures the strength of the floor inlay and/or is responsible for the maximum possible area load of the floor inlay. It can have an overall height of 50 to 150 mm, more preferably 80 to 120 mm. An overall height of 100±5 mm is particularly preferred. The area load should not be less than 3,000 kg/m² and the average area load should measure 3,800 kg/m².

The hollow chamber structure which forms the second material layer 2 can be manufactured from the same plastic as the first material layer 1 or from a similar plastic to the first material layer 1. The hollow chamber structure is preferably formed from a plastic which is reinforced with talcum.

Another, third material layer 3 is situated on the second or middle material layer 2 and/or the upper side 2a and likewise comprises a lower side 3b and an upper side 3a, wherein the lower side 3b is glued, fused or laminated to the upper side 2s of the second material layer 2 in the known and previously described way.

The third material layer 3 can consist of a plastic layer, wherein a fabric or interlace is applied, for example laminated, to the upper side 3a of said plastic layer. The fabric or interlace alone can also form the third material layer. When for example provided as a floor covering in the passenger space of a bus, the third material layer 3 can be rubbery in order to counteract slipping by the passengers on the floor. The material which forms the rubbery material layer 3 or its visible surface can for example be able to be dyed and/or printed on. It would thus be possible to avoid additionally laying a carpet, if a particular floor colour or a particular pattern on the floor is desired by the user for reasons of for example corporate identity and/or corporate design. The third material layer or its visible surface can also be formed by a plastic fabric or plastic interlace such as is for example offered by the firm LECO.

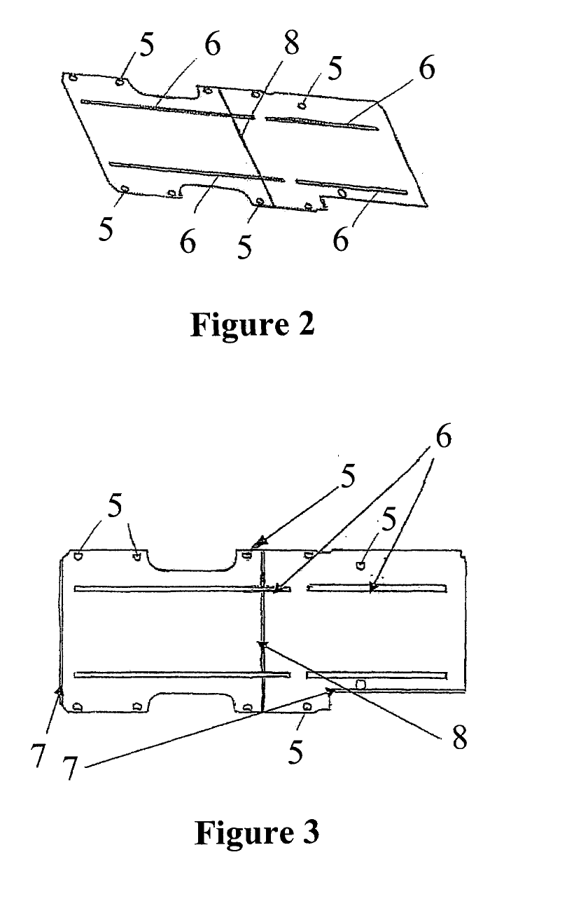

FIG. 2 shows a perspective view of a load floor which can be laid. The same view, but in a top view, is shown in FIG. 3. The load floor is preferably manufactured in one piece, but can also be manufactured from two or more parts which are only then joined together, either by a positive fit, mechanical sealing elements or for example by gluing, when they are laid on the container floor or vehicle floor. Preferably, however, the load floor is manufactured in one piece, wherein in this case, it comprises a half-cut groove 8 along which it can be folded together for storage and transport purposes and so as to be more easily installed in the container. The load floor comprises various functional elements which are additionally worked in either during the production or afterwards by moulding, punching, pressing or other machining methods. Specifically, a number of lashing ear lugs 5 are worked, for example punched, into the load floor of FIGS. 2 and 3, through which the lashing ears fastened to the load space floor can protrude through the floor inlay, such that the payload can be properly lashed. The lashing ear lugs 5 are for example punched out of the load floor and/or cut into it, for example by means of a laser cutting method. The lashing ear lugs 5 can additionally comprise partially or completely circumferential beadings on their circumference, such that the lashing ears which are not needed for lashing the payload can be folded over such that when folded over, they do not protrude beyond the surface of the load floor and thus do not present stumbling traps for the user and/or do not press the lashing ear into the surface of the load floor when payload is placed on the position of the lashing ear. Beading has the additional advantage that the hollow chamber structure is again closed in the region of the punching or cutting, such that neither liquid nor dirt can penetrate into the otherwise open hollow chamber region. Lashing rail lugs 6 can also be seen in the load floor of FIGS. 2 and 3, to which substantially the same applies as to the lashing ear lugs.

Lastly, beadings 7 in the region of the load space sliding door and the rear end edge of the load area can also be seen. They serve on the one hand to adapt the shape of the load floor in the regions in which payload is introduced into the load space or removed from the load space, such that the payload cannot press against the side of the load floor during loading, since the load floor is designed as an oblique plane in the region of the loading openings of the load space. Damage to the load floor in the region of the loading opening is thus avoided as far as possible.

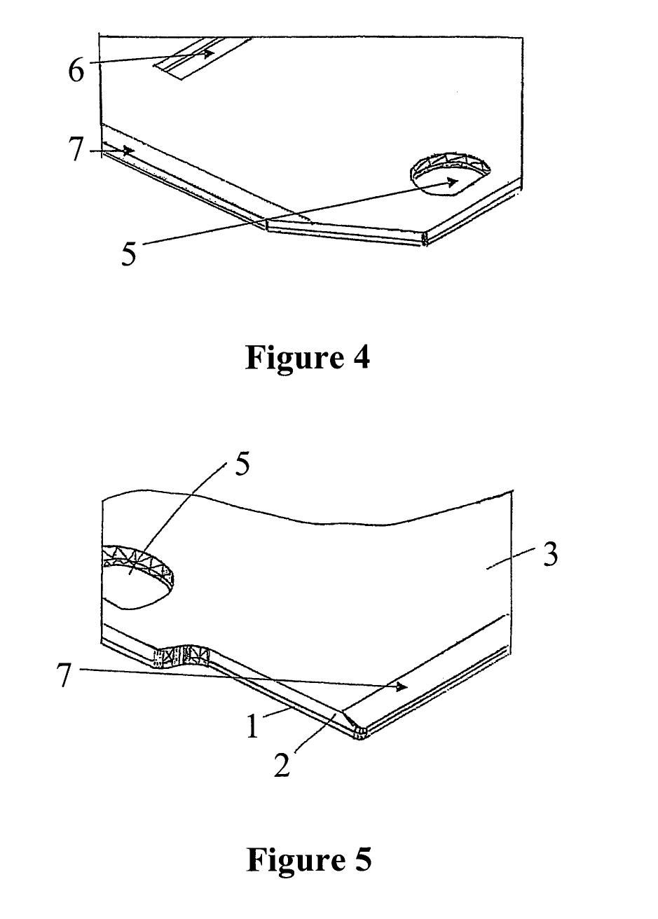

FIG. 4 shows a sectional detail of a load floor comprising a beading 7, a first perforation for a lashing rail lug 6 which is beaded on its inner sides, and a second perforation for a lashing ear lug 5 with no beading. At the lashing ear lug with no beading, it is possible to see into the hollow chamber structure of the second material layer 2. Moisture and dirt can penetrate into and collect in the visibly open regions of the hollow chamber structure. This makes it more difficult to clean the load floor, hence it is preferred if all the perforations in the load floor, and all the sides of the load floor, are closed either by beading or by other means, for example by cutting to size using a laser.

FIG. 5 likewise shows a lashing ear lug 5 with no beading, and a beading 7 in the region of a loading door, which is designed as an oblique plane such as has already been described above. It can likewise be seen that the sides of the load floor can be open in individual regions, for example in the region of cuts having a radius, such that individual open or partially open chambers of the second material layer 2 can be seen.

We claim:

1. A floor inlay for a container and/or container floor, comprising:
a first material layer comprising an upper side and a lower side; and
at least a second material layer comprising an upper side and a lower side;
wherein the first material layer is a plastic foam layer and the second material layer is a hollow chamber structure consisting of plastic; and
wherein the upper side of the first material layer is connected to the lower side of the second material layer such that the first material layer cannot be moved relative to the second material layer; and at least an upper side of the floor inlay/container floor is a closed area.

2. The floor inlay/container floor according to claim 1, wherein the hollow chamber structure is a tri-laminate comprising a lower layer, an upper layer and a spacing layer lying between them.

3. The floor inlay/container floor according to claim 1, wherein at least the surface of the upper side of the second material layer is a closed area and defines the upper side of the floor inlay/container floor.

4. The floor inlay/container floor according to claim 1, wherein at least the surface of the lower side of the first material layer is designed in the form of a closed skin.

5. The floor inlay/container floor according to claim 1, wherein the upper side of the first material layer is glued, fused, laminated or connected by a material fit to the lower side of the second material layer.

6. The floor inlay/container floor according to claim 1, wherein the first material layer and the second material layer are formed from the same plastic or from similar plastics.

7. The floor inlay/container floor according to claim 1, wherein when manufacturing the hollow chamber structure of the second material layer, the first material layer is connected to the second material layer inline.

8. The floor inlay/container floor according to claim 1, wherein the floor inlay/container floor comprises a third material layer comprising a lower side and an upper side, and the third material layer lies on the upper side of the second material layer.

9. The floor inlay/container floor according to claim 8, wherein the second material layer is open on its lower side and on its upper side.

10. The floor inlay/container floor according to claim 8, wherein the three material layers are formed from the same plastic or from similar plastics.

11. The floor inlay/container floor according to claim 10, wherein the second material layer is formed from a three-dimensionally moulded central sandwich layer with a smooth plastic sheet laminated on both sides.

12. The floor inlay/container floor according to claim 8, wherein the third material layer or the upper side of the third material layer is formed from a solid fabric or from an interlace.

13. The floor inlay/container floor according to claim 8, wherein the third material layer or the upper side of the third material layer is formed from a PP fabric.

14. The floor inlay/container floor according to claim 8, wherein the third material layer comprises a TPO coating.

15. The floor inlay/container floor according to claim 8, wherein the lower side of the third material layer is glued, fused, laminated or connected by a material fit to the upper side of the second material layer.

16. The floor inlay/container floor according to claim 8, wherein when manufacturing the hollow chamber structure of the second material layer, the first material layer and the third material layer are connected to the second material layer inline.

17. The floor inlay/container floor according to claim 1, wherein the container is a vehicle and the floor inlay is a vehicle floor for the passenger space or load space.

18. The floor inlay/container floor according to claim 1, wherein the floor inlay/container floor has a thickness of approximately 100 mm.

19. The floor inlay/container floor according to claim 1, wherein the maximum area load of the floor inlay/container floor is approximately 3,800 kg/m².

20. The floor inlay/container floor according to claim 1, wherein the weight of the floor inlay/container floor measures approximately 3,800 g/m².
